(19) United States
(12) Patent Application Publication
(10) Pub. No.: US 2008/0021771 A1
(43) Pub. Date: Jan. 24, 2008

(54) SYSTEMS AND METHODS FOR DEFINING PRICING CONDITIONS IN ELECTRONIC SALES APPLICATION ENVIRONMENTS

(76) Inventors: Ling Wu, San Jose, CA (US); David McCurley, Kennesaw, GA (US); Bin Zhou, Sunnyvale, CA (US); Mark Y.S. Chan, Mountain View, CA (US); Ramesh Anantharamaiah, Fremont, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/755,567

(22) Filed: May 30, 2007

Related U.S. Application Data
(60) Provisional application No. 60/809,728, filed on May 31, 2006.

(51) Int. Cl. G06Q 30/00; G06F 17/30

(52) U.S. Cl. 705/14

(57) ABSTRACT

A computer-implemented method of determining a discount for purchased items, the method comprising providing a plurality of items to be purchased by a customer, applying a recursive discount scheme for determining available discounts for said plurality of items to be purchased, selecting a highest discount value from said available discounts for said plurality of items, and notifying said customer of said highest discount value for said plurality of items.

### RELATED APPLICATIONS

This application claims the benefit of U.S. Provisional Patent Application No. 60/809,728, filed on May 31, 2006, the disclosure of which is hereby incorporated by reference in its entirety.

### BACKGROUND

1. Field of the Invention

The present invention relates to electronic catalog systems that include functionality for users to receive discounts and other price adjustments on items they wish to purchase or otherwise acquire.

2. Description of the Related Art

Many online systems provide services through which users can apply coupons to items they wish to purchase, rent, or otherwise obtain. For example, online shopping web sites commonly provide the option to enter a coupon code through which users can enter a pre-defined code to receive a discount on the items they wish to acquire (i.e., items in their “shopping cart”). These systems, however, most commonly provide the coupon entry and corresponding processing of the discount after the user has finalized his shopping cart. In most systems, only one discount may be entered before the purchase is made. In situations where the system seeks to apply multiple discounts to a shopping cart, the process may take an extended period of time wherein the system may not always apply the best combination of discounts to the cart.

### SUMMARY

Thus, it would be advantageous to provide a system for applying an optimal combination of discounts to a shopping cart within a quick response time.

In one embodiment, an electronic catalog containing discounts and groups is provided. Each discount or group may contain a description, path, and information as to whether or not the discount or group may be combined with other discounts or groups and the order in which to apply the discount/group. In certain embodiments, the system creates a master hierarchy of all possible groups for the electronic catalog. In certain embodiments, a personalized hierarchy referencing the master hierarchy may be generated and updated in response to specific items entered into a user's shopping cart.

A hierarchy may then be used to inform a user of discounts that are applicable to his shopping cart. In certain embodiments, the user may also be informed of additional discounts available for his shopping cart if he added other items.

Another embodiment is a computer-implemented method of determining a discount for purchased items. This method includes: providing a plurality of items to be purchased by a customer; determining a plurality of applicable discounts for said plurality of items to be purchased; applying a discount determination function for selecting a highest discount value from said plurality of applicable discounts for said plurality of items; and notifying said customer of said highest discount value for said plurality of items.

Yet one additional embodiment is a computerized method of determining the lowest cost for a plurality of purchased items in an electronic shopping cart. This method includes: providing an electronic shopping cart comprising a plurality of items to be purchased by a customer; determining a plurality of applicable discounts to said plurality of items; providing a discount determination function which determines the highest discount value from said applicable discounts for said plurality of items; and notifying said customer of said highest discount value for said plurality of items in said shopping cart.

One additional embodiment is a computer-readable medium having data stored thereon, the data comprising: a incentive discount data tree storing discounts and incentives, the first data tree including at least one non-leaf node and at least one leaf node, wherein the at least one non-leaf node comprises data representing a group and the at least one leaf node comprises data representing a discount.

Still another embodiment is a computer system for determining a discount for purchased items comprising: first means for providing a plurality of items to be purchased by a customer; second means for determining a plurality of applicable discounts for said plurality of items to be purchased; third means for applying a discount determination function for selecting a highest discount value from said plurality of applicable discounts for said plurality of items; and fourth means for notifying said customer of said highest discount value for said plurality of items.

Neither this summary nor the following detailed description purports to define or limit the invention. The invention is defined only by the claims.

### BRIEF DESCRIPTION OF THE DRAWINGS

Specific embodiments of the invention will now be described with reference to the following drawings, which are provided by way of example, and not limitation.

FIG. 1 shows a sample tree for an electronic catalog.

FIG. 2A shows a sample data structure, a “flat file,” for storing information related to a master hierarchy tree.

FIG. 2B shows a visual representation of the data stored in the flat file.

FIG. 3 shows a flow chart for one embodiment of a process for purchasing items in an electronic catalog system.

FIG. 4A shows an example shopping cart for a user.

FIG. 4B is an example of a personal hierarchy tree created from the master hierarchy trees of FIGS. 2A and 2B for the shopping cart of FIG. 4A.

FIG. 5 shows a flow chart for one embodiment of a process for creating a hierarchy tree.

FIG. 6 illustrates a sample recursive method for reconciliation.

FIG. 7 illustrates an electronic catalog system that includes components for implementing some or all of the features and services depicted in FIGS. 1-4.

### DETAILED DESCRIPTION

Various embodiments described herein provide systems and computer-implemented methods for applying price adjustments to items that are purchased on-line. In one embodiment the price adjustments are applied as items from an electronic catalog are placed within an electronic shopping cart. A shopping cart may, for example, be in the form of shopping lists for making purchases, rental queues used for movie/video rentals, or wish/gift registry lists of desired gifts.

Certain aspects may be implemented as part of or in conjunction with an interactive system, such as a web site system, that hosts an electronic catalog of items that are available for purchase and/or rental. The items represented in the electronic catalog may include, for example, physical products that are shipped to customers or picked up at a local store, digital products (e.g., book, music, video, and video game files) that are downloaded or transmitted to customers' computing devices or set-top boxes, tickets for travel or events, services provided to customers, or any combination thereof. The catalog may contain only the offerings of a single merchant, or may include the offerings of many different merchants and/or online sellers.

As used herein, an input device can be, for example, a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

The invention is operational with numerous other general purpose or special purpose computing system environments or configurations. Examples of well known computing systems, environments, and/or configurations that may be suitable fore use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN) or Wide Area Network (WAN) may be a corporate computing network, including access to the Internet, to which computers and computing devices comprising the system are connected. In one embodiment, the LAN conforms to the Transmission Control Protocol/Internet Protocol (TCP/IP) industry standard.

As used herein, media refers to images, sounds, video or any other multimedia type data that is entered into the system.

A microprocessor may be any conventional general purpose single- or multi-chip microprocessor such as a Pentium® processor, a Pentium® Pro processor, a 8051 processor, a MIPST processor, a Power PC® processor, or an ALPHAS processor. In addition, the microprocessor may be any conventional special purpose microprocessor such as a digital signal processor or a graphics processor. The microprocessor typically has conventional address lines, conventional data lines, and one or more conventional control lines.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as LINUX, UNIX or MICROSOFT WINDOWS®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code.

A web browser comprising a web browser user interface may be used to display information (such as textual and graphical information) to a user. The web browser may comprise any type of visual display capable of displaying information received via a network. Examples of web browsers include Microsoft's Internet Explorer browser, Netscape's Navigator browser, Mozilla's Firefox browser, PalmSource's Web Browser, or any other browsing or other application software capable of communicating with a network.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

In one embodiment, a system is provided which creates a hierarchy of groups and discounts for items in the electronic catalog. Discounts within the hierarchy may only apply to items within a particular category. For example, only items from the electronics department may qualify for a 10% discount. These types of price adjustments thereby fall within a particular “group” since the price adjustment only applies to items within a predetermined category. Each discount or group may contain a description, path, or other information which describes whether or not the items that fall within the group of the discount can be combined with other discounts. This is known as the “stackability” of the discount. For example, the purchase of a television may qualify for a 10% discount because it is from the electronics department. However, the purchase of the television may also qualify for a discount wherein the purchaser gets a free radio with every television that is purchased. The system controls whether the purchaser can receive both discounts, or just one discount when they qualify for both. If purchases are “stackable” then they can be combined, and the purchaser receives both discounts. If they are non-stackable, then the purchaser receives only one discount even though they qualify for both. The order in which the discount may be applied is known as the “priority.” Discounts with higher priority will be given when the discounts are non-stackable.

In one embodiment, the hierarchy is in the form of a tree structure, which may be recursively (or iteratively) traversed or otherwise referenced to using a discount determination function to determine which discounts, if any, to apply to a user's shopping cart. As used herein, a discount determination function is any formula or algorithm which allows for the determination of applicable discounts and/or allows for the selection of the highest discount value for a plurality of items. Utilizing a discount determination function or some other discounting method, the system may then inform a user of the discounts that are applicable to the shopping cart.

In certain embodiments, a master hierarchy tree is created using all available groups in the electronic catalog. The master hierarchy tree may be used by the system in the creation of a personal hierarchy tree to give structure to discounts relevant to a user's shopping cart.

In certain embodiments, the personalized hierarchy may be generated and updated by first creating a tree using the group nodes from the master hierarchy tree corresponding to discounts applicable to a user's shopping cart, and then adding those discount nodes to the tree. The personalized hierarchy is a compilation of the discounts that are available for the items that are currently within the shopping cart. For example, as a user adds or removes an item to his shopping cart, the system may update the personalized hierarchy generated for the cart. The personalized hierarchy may then be used to inform a user of which discounts, if any, are applicable to his shopping cart.

In certain embodiments, a user may be informed of additional discounts that would be made available to his shopping cart if he were to add other items. This allows a user to take advantage of potential discounts currently inapplicable to his cart.

I. Hierarchy Trees

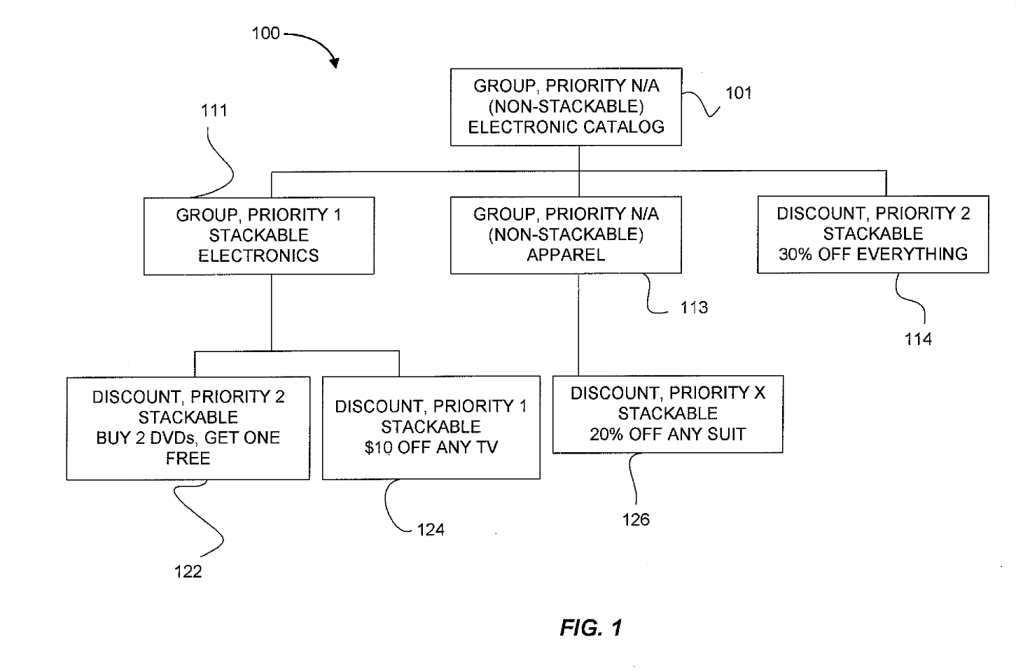

In certain embodiments, a hierarchy tree may be used for assisting in the application of discounts to a shopping cart. In these embodiments, a “tree” type computer data structure with a set of linked nodes may be used. FIG. 1 shows a sample tree 100 for an electronic catalog 101. Each node has zero or more child nodes, which are below it in the tree, which grows down, not up. For example, the “Electronics” group node 111 has two children 122 and 124, while the “30% off everything” discount node 114 has no children. A node that has a child is called the child's parent node. Thus, the “Electronics” group node 111 is the parent of nodes 122 and 124. A child has at most one parent; a node without a parent is called the root node (or root). The “Electronic Catalog” group node 101 is the root node of the tree in FIG. 1. Nodes with no children are called leaf nodes. There are four leaf nodes 114, 122, 124 and 126 in FIG. 1. In certain embodiments, the tree may be an ordered tree, while in other embodiments the tree may be an unordered tree.

In certain embodiments, a hierarchy tree is composed of two types of nodes, group nodes and discount nodes. Group nodes may have both group nodes and discount nodes as children. As illustrated in FIG. 1, the “Electronics” group node 111 has two discount nodes 122 and 124 as children. Group nodes are nodes that may be used to identify their descendant discount nodes. For example, the group node “Electronics” 111 is the parent node to child discount nodes that relate to electronics, such as DVDs 122 and televisions 124. In certain embodiments, discount nodes are always leaf nodes and group nodes are always parent nodes.

Discount nodes are nodes that identify price adjustments for shopping carts. Discount nodes may include any kind of adjustment, such as conditional adjustments (ex. if you buy two shirts, you get the third shirt free). Some popular conditional adjustments are: buy x, get y (ex. buy a TV, get a free DVD player); more you buy, more you save (ex. buy three tools, get 10% off); threshold deals (ex. buy $100 of jewelry, get 10% off); shipping discounts (ex. get $10 off shipping if you purchase 2 DVDs); tier discounts (ex. buy one shirt for $10, two shirts for $9 each, or three or more shirts at $8 each). The tree 100 in FIG. 1 contains four discount nodes: (1) Buy 2 DVDs, Get 1 Free 122, (2) $10 off any TV 124, (3) 20% off any suit 126, and (4) 30% off everything 114. Discounts may also fall into two classes, relevant discounts and potential discounts. Any discount that a shopping cart already qualifies for is considered a relevant discount. On the other hand, any discount that a shopping cart could qualify for is considered a potential discount.

In certain embodiments, each node may be composed of four elements: a path, information on whether or not the node is stackable, a priority if the node is stackable, and a description. In other embodiments, a node may contain other elements, such as how many times the node has been accessed, which user the node has been accessed for, and so on.

The path element of a node identifies the location of the node in the tree. In one embodiment, the path element may be a text string. For example, the path for the same “$10 off any TV” discount node 124 might be “\ELECTRONIC CATALOG\ELECTRONICS\”. In another embodiment, the path element may state what level the node is found and who the parent of the node is. For example, in FIG. 1, the path description for the “$10 off any TV” discount node 124 could be “Level 3, child of Electronics group node” 111. Any known path storage format may be used to store data for the path element. The path element of an adjustment node is especially useful to locate its parent group node when creating a personal hierarchy tree, as will be discussed in further detail below.

The stackability element defines whether or not the node is stackable. For example, the two discount “Buy 2 DVDs, Get 1 Free” 122 and “$10 off any TV” 124 are stackable. If both discount 122 and 124 were found applicable to a shopping cart—i.e., if a user had at least two DVDs and a television in his shopping cart—then those two discount 122 and 124 could be combined and applied to the cart. In other words, the user could get another DVD for free as well as $10 off his television. On the other hand, if either of those discount 122 and 124 were defined as non-stackable, then the user would not be able to get both discount 122 and 124, but instead would receive the best or highest discount available between the two 122 and 124.

The priority element of a node defines the order in which the node is applied. Any well known method to order several items may be used to store priority data. In certain embodiments, the priority may be an integer value from zero to negative numbers, where a node with priority zero is always processed first, a node with a negative one priority is processed after the node with the highest positive priority, and negative numbers below negative one are processed in numerical order. In other embodiments, other priority values may be used, including, but not limited to, decimal values between zero and one, percentages, characters, and strings.

The priority in which discounts are applied has an impact on the final value of the cart. For example, the electronic catalog of FIG. 1 shows an embodiment which uses integer priority values. If a user decides to purchase a television, then the final discounts applicable to the user after reconciliation will be “$10 off any TV” 124 with a priority of one and “30% off of everything” 114 with a priority of two, as will be discussed further below. If the television costs $100, then the final value of the can would be $63, since first $10 off of $100 is $90, and then 30% off of $90 is $63. On the other hand, the priority were reversed, i.e., if the “$10 off any TV” 124 had a priority of two and “30% off of everything” 114 had a priority of one, then the final value of the cart would be $60, since first 30% off $100 is $70, and then $10 offof $70 is $60.

Stackability and priority also relate to the ability of nodes to combine with one another before they are inherited by their parent node. In certain embodiments, the stackability and priority elements of group nodes can be inherited by their descendant discount nodes as they move up the tree, but discount nodes may not inherit group nodes. For example, with reference to FIG. 1, the “Apparel” group node 113 may inherit the “20% off any suit” discount node 126 if the discount 126 is applicable to a shopping cart. The group node would inherit the discount node by a process where the discount node(s) would move up one level in the tree to replace the group node, but where the discount node(s) would inherit the group node's priority and stackability elements. Thus, after inheritance, the third level, stackable “20% off any suit” discount node 126 would no longer exist, but instead the “Apparel” group node 113 would be replaced with a “20% off any suit” discount node with the group node traits of non-stackability and inapplicable priority.

The description element of a node differs depending on whether the node is a group node or a discount node. The description element of a group node consists of an identification of the types of nodes which descend from the group node. In one embodiment, the description element of a group node is a description of the category that the descendant discount nodes belong to. For example, the group node described as “Apparel” 113 is the parent of the apparel-related discount node 126 for receiving 20% off of any suit.

On the other hand, the description element of a discount node consists of details on the discount to be applied by the discount node. For example, in FIG. 1, the third level discount node that is the child of the Apparel group node 113 has a description element of “20% off any suit” 126. The description element of a discount node may also include item lists such as inclusion lists and exclusion lists. Inclusion lists may be used to specify items that may be the recipients of discounts. Consequently, any item that is not a member of an inclusion list will not qualify for a discount. For example, if a “10% off any television discount node” included an inclusion list for televisions only made by Panasonic, and no other brand of televisions was part of the inclusion list, then only a Panasonic brand television would qualify to receive the 10% discount. The system may also employ exclusion lists, where items are specified that may not receive discounts. Thus, if a “10% off any television discount node” included an exclusion list for televisions only made by Panasonic, and no other brand of televisions was on an exclusion list, then any television other than a Panasonic brand television would qualify to receive the 10% discount.

The implementation and use of a hierarchy tree advantageously expedites the amount of time required to apply the best combination of all relevant discounts to a shopping cart. By organizing the nodes according to the content of the node as well as by organizing the relationships between nodes using their placement in the tree, the system is advantageously able to decrease the amount of processing time needed to return relevant discounts for certain items when called by the system by pre-processing the nodes in advance.

In one embodiment of the system discussed herein, a master tree hierarchy is generated containing all available groups for an electronic catalog. The master tree will thus contain a general structure for all types of discounts available in the electronic catalog due to the use of groups as categorizing their descendant discounts. The master tree may then be referenced by the system in the process of creating a personal tree for a user's shopping cart, as discussed in further detail below.

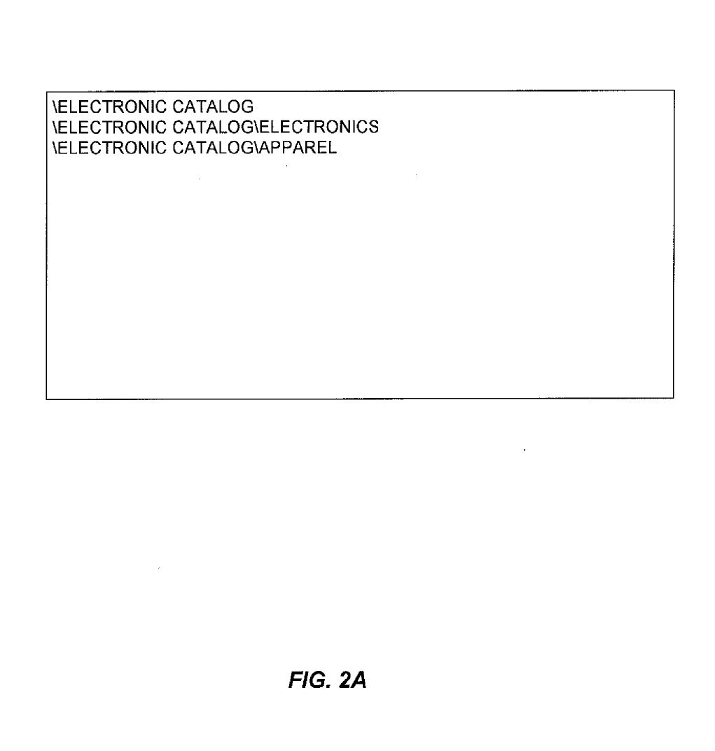

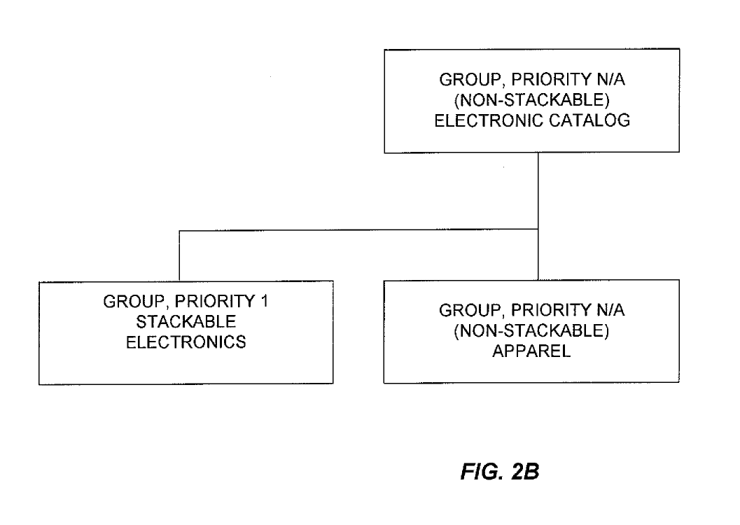

FIGS. 2A and 2B illustrate a sample master hierarchy tree based on the sample hierarchy tree displayed in FIG. 1. FIG. 2A shows a sample data structure, a “flat file,” for storing information related to a master hierarchy tree. The hierarchy data is stored as strings of text, wherein different levels in the tree are demarcated by a “” symbol. Thus, the path of the first level root node is displayed as “ELECTRONIC CATALOG” while the path of the second level group node, “Electronics,” is stored as “\ELECTRONIC CATALOG\ELECTRONICS”.

FIG. 2B shows a visual representation of the data stored in the flat file. In certain embodiments, such as the embodiment shown in FIGS. 2A and 2B, only group nodes are stored in the master hierarchy tree. Thus, as it can be seen when comparing FIG. 2B to FIG. 1, discount nodes such as “30% off everything” (114 in FIG. 1) does not appear in the hierarchy tree.

II. Reconciliation

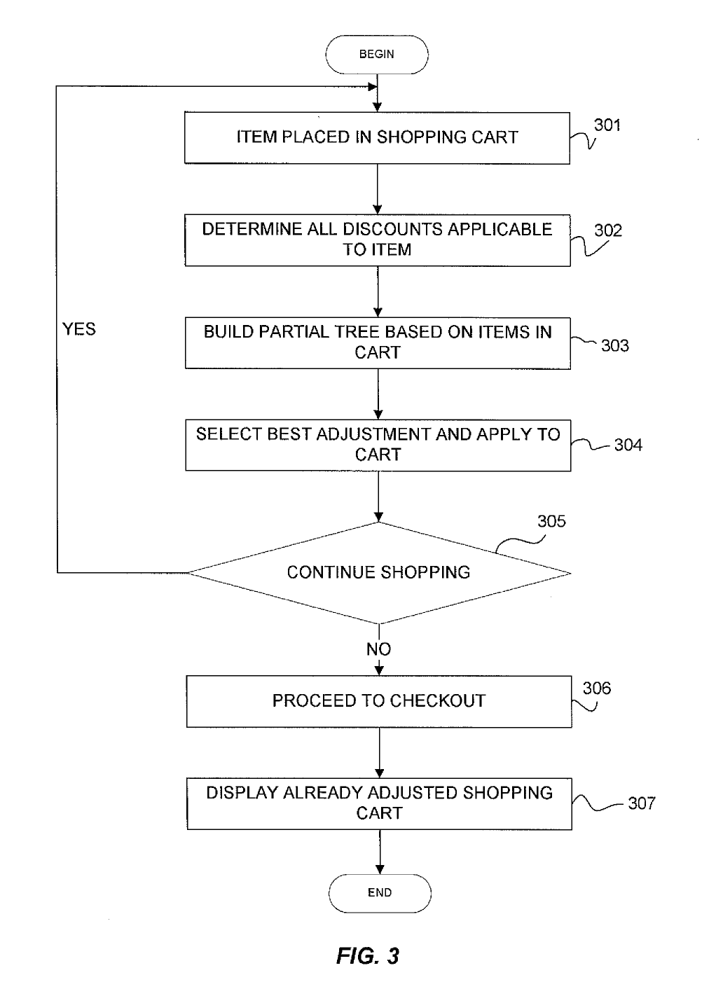

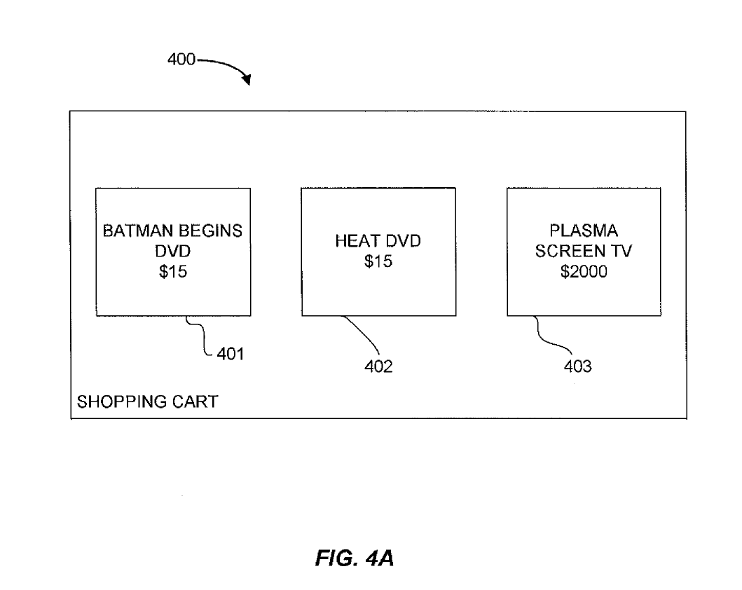

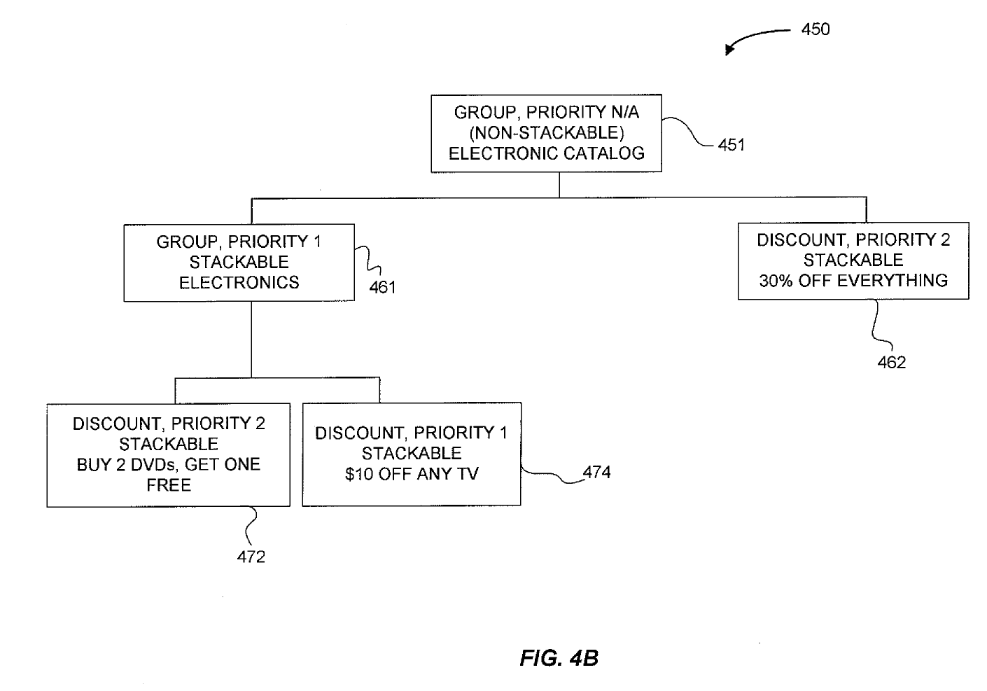

FIG. 3 shows a flow chart for one embodiment of a process 300 for purchasing items in an electronic catalog system using certain inventive features described herein. At state 301, a user has found an item he is interested in acquiring and consequently places it in his shopping cart. FIG. 4A shows an example shopping cart for a user. Items may be selected and placed into an electronic shopping cart according to any well known method in the art. In response to each item placed in (or removed from) the user's shopping cart, the system at state 302 determines all discounts available in the electronic catalog that are applicable to the item placed into the cart (“applicable discounts”). In one embodiment, the system locates applicable discounts using an iterative process, such as by examining the applicability of each discount in the electronic catalog against the new item placed in the cart. Alternatively, the system may, with each new item placed in the cart, locate applicable discounts for not only the new item placed in the cart, but also for all items placed in the cart.

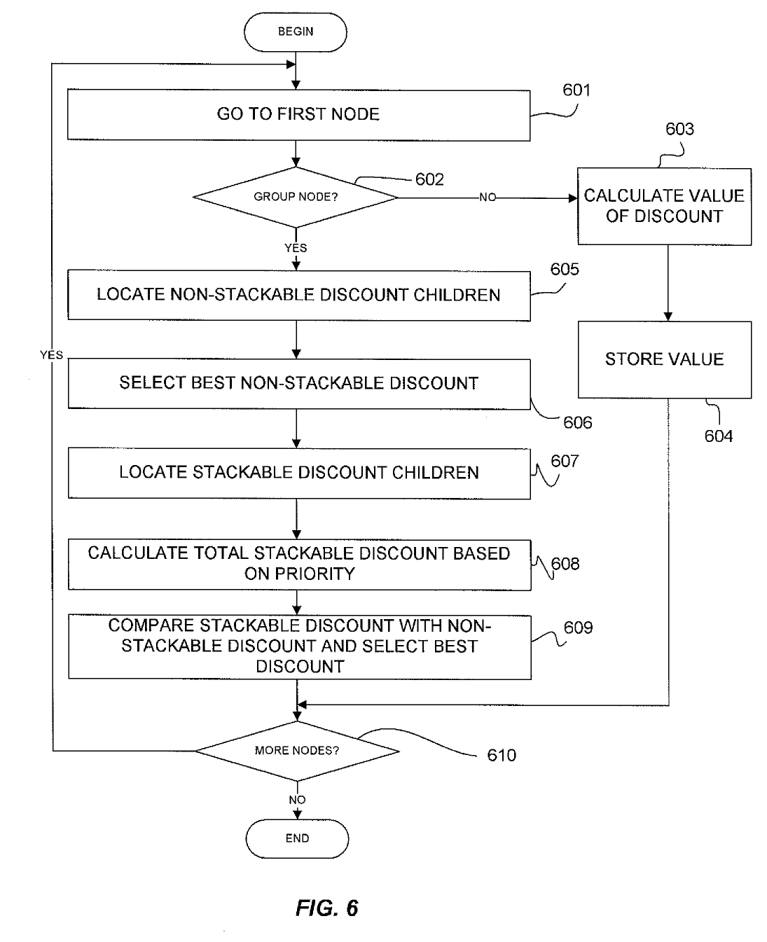

At state 303, the system builds a personal hierarchy tree using the applicable discounts determined in state 302 and their corresponding groups based on the items in the user's shopping cart. FIG. 4B is an example of a personal hierarchy tree created from the master hierarchy tree of FIGS. 2A and 2B for the shopping cart of FIG. 4A, and will be discussed in more detail below. If a personal hierarchy tree previously existed for the shopping cart before the item was added (or removed), then the system may update the personal hierarchy tree instead of building a new personal hierarchy tree. Then, based on the personal hierarchy tree, at state 304 the system advantageously selects, or reconciles, the best combination of discounts to apply to the cart. This process, known as reconciliation, will be discussed further below with reference to FIG. 6. Next, the system moves to a decision state 305 wherein a determination is made by the user as to whether or not the user would like to continue shopping. If the user chooses to continue shopping, the user returns to state 301. If, however, the user does not choose to continue shopping, the system proceeds to check the user's shopping cart out at state 306 by finalizing the cart's contents. Then, in state 307, the adjusted shopping cart, which may include an adjusted price, is displayed to the user.

FIG. 4A shows a shopping cart 400 for a user containing three items. Two items in the shopping cart 400 are digital video discs (“DVD”) for the movies “Batman Begins” 401 and “Heat” 402, each priced at $15. The third item in the cart is a plasma screen television 403 priced at $2000. FIG. 4B shows a personal hierarchy tree 450 built for the shopping cart 400 of FIG. 4A using the applicable nodes from the hierarchy tree 100 of FIG. 1 according to one embodiment of the invention. In certain embodiments, and as shown in the sample figures herein, the system builds a personal hierarchy tree for a user by only selecting discounts from an electronic catalog and groups from a master hierarchy tree that are relevant to items in the user's shopping cart. The relevant nodes may be found using any well known tree search algorithm including breadth-first search, depth-first search, iterative-deepening search, depth-limited search, bidirectional search, uniform cost search or some other search algorithm.

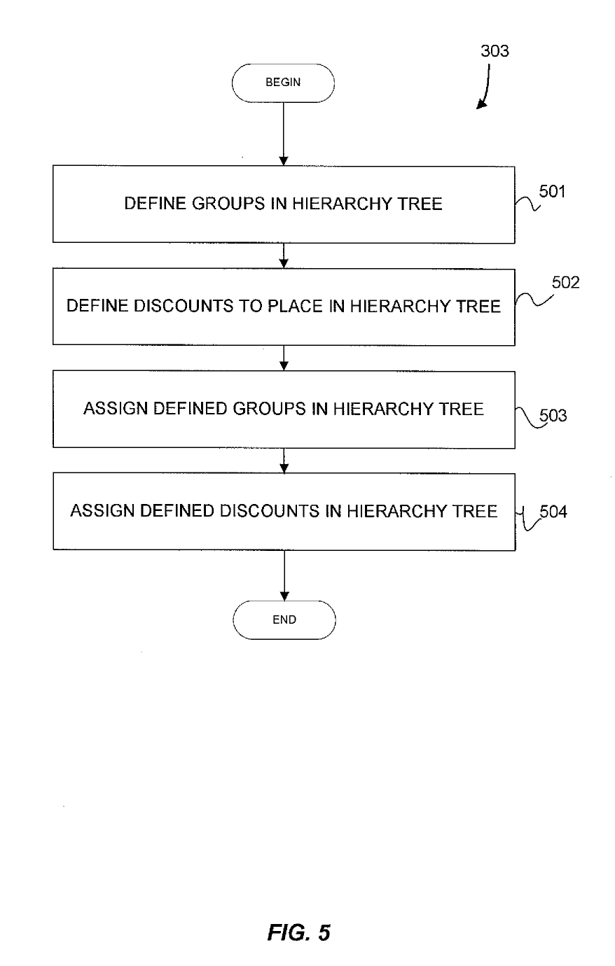

FIG. 5 shows a flow chart for one embodiment of a process 500 for creating a hierarchy tree (state 303 from FIG. 3), such as the personal hierarchy tree. First, at state 501 the system defines all group nodes that will be placed in the tree. In certain embodiments, the system may define the group nodes to be placed in the personal hierarchy tree by reference to the path element of each applicable discount, which has been previously determined. For example, as it can be seen when comparing FIG. 4B to FIG. 1, the group node related to apparel was not selected as part of the personal hierarchy tree in FIG. 4B because no apparel discounts are applicable discounts (because no apparel items exist in the shopping cart, 400 in FIG. 4A). Next, the system at state 502 defines all discount nodes that will be placed in the tree, i.e., the predetermined applicable discounts. With all node definitions complete, the system then moves on to assigning all nodes to a location in the tree. First, at state 503 the system assigns the group nodes in the hierarchy tree. Then in state 504 the system assigns the discount nodes in the hierarchy tree, such as applicable discounts in a personal hierarchy tree. Creation of the hierarchy tree is then complete.

In certain embodiments, a personalized hierarchy tree may also be built for a user based on nodes related to items that were not selected for his shopping cart but that the system predicts would be of interest to the user. This would allow for the system to notify the user of potential discounts that might be of interest to the user. For example, if the system predicts that the user with the shopping cart 400 from FIG. 4A would be interested in purchasing a receiver, and a discount for a free DVD player with the purchase of both a television and receiver existed, then the system may inform the user that if he purchased the receiver in addition to the television already in his cart he would receive a free DVD player. The system may determine which items and corresponding nodes are of interest to the user based on any well known form in the art. For example, the system may take into account the user's viewing history, browsing history, purchase history, wish list, shopping cart contents, or any other data on the user to predict items of interest to the user. In certain embodiments, the system may use a recommendations engine to determine which items would be of interest to the user.

As noted above, in certain embodiments, the system may automatically select the best discounts available to a user and apply those discounts to the user's shopping cart. This process of reconciliation is especially important in certain embodiments where nodes in the hierarchy can inherit other nodes. FIG. 6 illustrates a sample recursive discount determination function for reconciliation (state 304 from FIG. 3) according to one embodiment. Although in FIG. 6 the method of traversal is recursion, in other embodiments, the system may navigate a hierarchy tree according to other well known methods in the art, such as iteration.

The system begins at state 601 by selecting the first node in the personal hierarchy tree, such as the root node. Next, the system moves to a decision state 602 wherein a determination is made whether the current node is a group node. If the node is not a group node, then it must be an discount node, and the system moves to state 603 wherein the system applies the discount to the shopping cart and in state 604 stores the value of the adjusted cart. The system then moves to state 610 to determine if any other nodes in the tree need to be evaluated. If, however, at state 602 the determination is made that the node is a group node, then the system moves to state 605 wherein the system locates all non-stackable group children to the group node, and then at state 606 selects the best non-stackable group to apply to the shopping cart. After selecting the best non-stackable group in state 606, the system locates the children of the group node that are stackable groups in state 607. The system then calculates the total stackable adjustment to apply to the shopping cart based on all of the applicable stackable discount nodes and their corresponding priorities in state 608. With the comparative adjustment values between the stackable and non-stackable discounts calculated, the system compares the two values in state 609 to determine the best discount to apply to the user's shopping cart. In certain embodiments, when one type of discount, either non-stackable or stackable, does not exist after state 602, then the system would proceed to evaluate the other type of discount. Returning to FIG. 6, the system then moves from state 609 to decision state 610 wherein a determination is made whether any more nodes exist to process. If additional nodes exist, the system recursively returns to state 602. If, however, no additional nodes exist, the system moves to an end state.

The process of FIG. 6 is thus one embodiment of a method to select the best reconciliation to apply to a shopping cart. For example, if the user with the shopping cart 400 shown in FIG. 4A decides to check out with the items displayed, the system will automatically reconcile between all available discounts, which are the discounts assigned in the personal hierarchy tree 450 of FIG. 4B, in order to provide the best and/or largest overall discount for the user. The system may recursively traverse the personal hierarchy tree 450 according to the process in FIG. 6 in order to determine the best combination of discounts that apply to the shopping cart 400. The system will find that both discounts for receiving a third DVD free 472 and $10 off any television 474 are available to the user with the shopping cart 400 shown in FIG. 4A since both discounts 472 and 474 are stackable. Furthermore, the priority is irrelevant between the two discounts since applying one discount does not affect the other. The two discounts 472 and 474 may then be considered as one combined discount, move up to the place of the parent 461 and inherit the stackability and priority traits of the parents. Thus, the discounts 472 and 474, previously independent, will now be a combined, stackable adjustment with a priority of one (traits inherited from the Electronics group). The combined discount will then be considered in comparison with the 30% off discount 462. Since both the combined discount and the 30% off discount 462 are stackable, they will both be applied to the shopping cart. Similarly, as before, the priority here is irrelevant since applying one discount does not affect the other. As a result of the reconciliation with respect to FIGS. 4A and 4B, the system will find that all three discounts 462, 472 and 474 apply to the shopping cart.

In certain embodiments, nodes and any corresponding reconciliation may not only relate to items purchased in an electronic catalog, but to different steps of the purchasing process as well. For example, in certain embodiments there may be nodes related to the shipping process, applying tax, or discounts between items or after all items are selected but before shipping and tax is considered. Consequently, reconciliation may also take into account these different steps in the online purchase process in order to apply the best overall value to the shopping cart of the user.

III. Example System Components

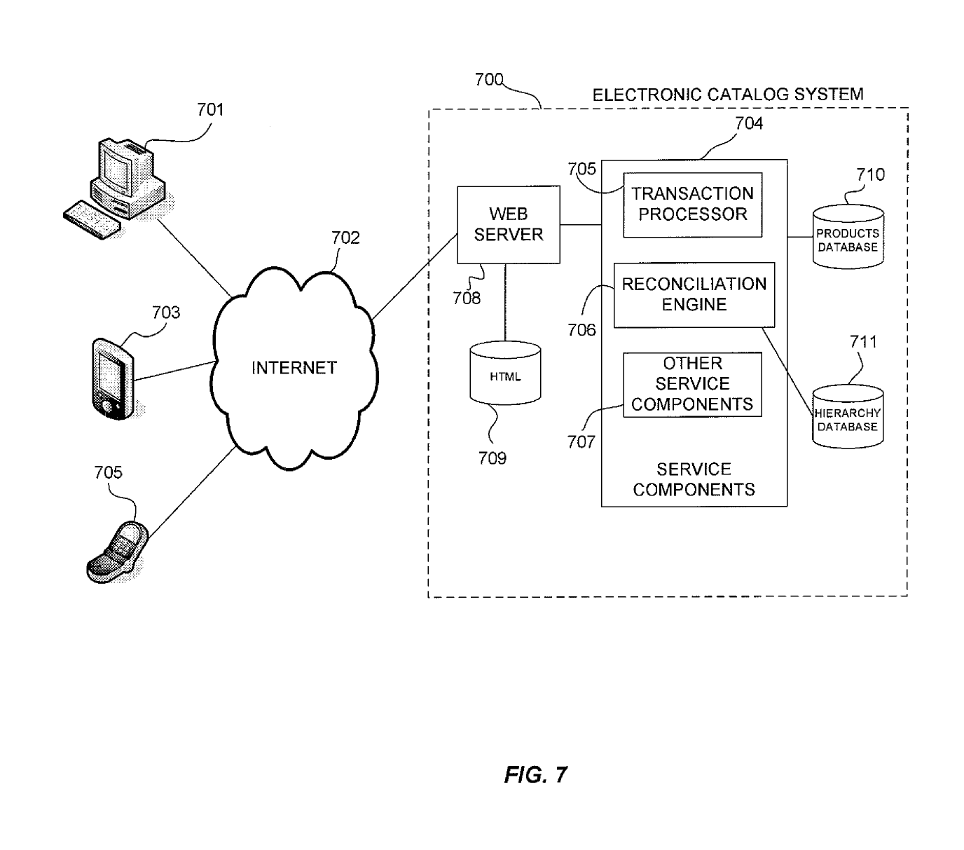

FIG. 7 illustrates an electronic catalog system 700 with a set of components for implementing some or all of the embodiments and features described above. The electronic catalog system 700 can be accessed remotely via the Internet 702 from a PC 701, PDA 703, cellular phone 705, or other type of computing device that runs a web browser program. The electronic catalog system 700 includes a web server 708 (which may be implemented using any number of physical servers), a database of HTML (hypertext markup language) content 709, a set of “service components” 705 (three of which are shown), a products database 710, and a hierarchy database 711—all of which may be implemented using general purpose computers and associated software. The various components of the electronic catalog system 700 may run, for example, on one or more servers (not shown).

The HTML database 709 contains, among other things, templates, scripts, and HTML content used to generate item detail pages, search result pages, browse node pages, and other types of pages that may be displayed during the course of a browsing session. The products database 710 contains data related to the products/items represented in the electronic catalog. This data may, for example, include price, product descriptions, product images, availability information, customer reviews, average customer ratings, and/or other types of product-related information as is known in the art.

The hierarchy database 711 stores information related to hierarchies. The information stored for a given hierarchy may include, for example, nodes, including group and discount nodes, as well as the hierarchy trees formed from those nodes. Although a single hierarchy database 711 is shown for purposes of illustration, the various types of hierarchy information may be distributed across a number of different databases, and/or may be stored in other types of data repositories (e.g., flat files).

The web server 708 accesses the service components 705 in response to page requests from users. The service components 705 may run on one or more general purpose computers, which may be separate from the web server computer(s). The service components 705 include, among other things, a transaction processor 705 and a reconciliation engine 706. Other service components 707, such as a search engine, may be included in certain embodiments. In one embodiment, the search engine provides users with the ability to search for products in the products database.

The transaction processor 705 provides functionality for users to select and purchase items from the electronic catalog. The reconciliation engine 706 is responsible for applying the relevant discounts from the hierarchy database 711 to a user's shopping cart. To reconcile discounts to a shopping cart, the transaction processor 705 adds items from the products database 710 to a user's shopping cart based on requests from the user received through the web server 708. The contents of the shopping cart are then analyzed by the reconciliation engine 706 with reference to the hierarchy database 711, which contains information on discounts, in order to apply any relevant discounts to the shopping cart. The adjusted shopping cart information is then sent back to the user over the Internet 702 via the web server 708.

As will be appreciated, FIG. 7 is merely illustrative of one type of system in which the inventive features may be embodied. In other embodiments, these features may, for example, be implemented in an interactive television system, an online services network, or some other type of interactive system.

IV. Conclusion

All of the features described above may be embodied in, and automated by, software modules executed by general purpose computers. The software modules may be stored in any type of computer storage device or medium. All combinations of the various embodiments and features described herein fall within the scope of the present invention.

Although the various inventive features and services have been described in terms of certain preferred embodiments, other embodiments that are apparent to those of ordinary skill in the art, including embodiments which do not provide all of the benefits and features set forth herein and do not address all of the problems set forth herein, are also within the scope of this invention. For example, although certain examples described above involve applying discounts to items in an electronic shopping cart, the invention may also be used in other systems, such as financial software, tax preparation, or statistical interpretation, The scope of the present invention is defined only by reference to the appended claims.

What is claimed is:

1. A computer-implemented method of determining a discount for purchased items, the method comprising:
providing a plurality of items to be purchased by a customer;
determining a plurality of applicable discounts for said plurality of items to be purchased;
applying a discount determination function for selecting a highest discount value from said plurality of applicable discounts for said plurality of items; and
notifying said customer of said highest discount value for said plurality of items.

2. The computer-implemented method of claim 1, wherein the discount determination function is a recursive function.

3. The computer-implemented method of claim 1, wherein applying said discount determination function comprises storing said applicable discounts to a data structure.

4. The computer-implemented method of claim 1, wherein the data structure comprises a group and a discount.

5. The computer-implemented method of claim 3, wherein the group further comprises a name, a priority, and an indication of stackability.

6. The computer implemented method of claim 3, wherein the applicable discounts comprise a name, a priority, and an indication of stackability.

7. The computer-implemented method of claim 3, wherein the applicable discounts comprise a discount rule.

8. The computer-implemented method of claim 7, wherein the discount rule comprises one or more of a general discount rule, a bonus/step rule, and a tier scheme rule.

9. The computer-implemented method of claim 2, wherein the data structure is a tree structure having a plurality of nodes and the group comprises a non-leaf node having at least one sub-node and the discount comprises a leaf node.

10. The computer-implemented method of claim 7, wherein the general discount rule comprises a condition and an adjustment, and wherein if the shopping cart satisfies the condition, the shopping cart receives the adjustment.

11. The computer-implemented method of claim 7, wherein the bonus/step rule comprises a qualified item and an adjustment, and wherein if the shopping cart includes a quantity of the qualified item exceeding a threshold quantity, an additional qualified item is discounted.

12. The computer-implemented method of claim 7, wherein the tier scheme rule comprises a qualified item and an adjustment, and wherein the size of the adjustments increases based on the quantity of the qualified item in the electronic shopping cart.

13. The computer implemented method of claim 9, wherein traversing the data structure to determine a highest value discount for the electronic shopping cart comprises:
calling a discount determination function with a first node in the tree structure as an input parameter, the discount determination function configured to determine whether a first node in the tree structure is a group or a discount.

14. The computer-implemented method of claim 13, wherein if the node is a discount:
applying the discount rule of the discount to the electronic shopping cart, and deriving a discount value of the discount.

15. The computer-implemented method of claim 13, wherein if the node is a non-leaf node group, recursively calling the discount determination function for each sub-node of the group.

16. The computer-implemented method of claim 13, wherein if the discount includes an indication of stackability that indicates that the node is stackable:
applying the discount rule of the discount to the electronic shopping cart, and deriving a discount value of the discount; and
determining an accumulated discount value by combining the discount value of the discount with another discount value derived from another discount.

17. A computerized method of determining the lowest cost for a plurality of purchased items in an electronic shopping cart, comprising:
providing an electronic shopping cart comprising a plurality of items to be purchased by a customer;
determining a plurality of applicable discounts to said plurality of items;
providing a discount determination function which determines the highest discount value from said applicable discounts for said plurality of items; and
notifying said customer of said highest discount value for said plurality of items in said shopping cart.

18. A computer-readable medium having data stored thereon, the data comprising:
a incentive discount data tree storing discounts and incentives, the first data tree including at least one non-leaf node and at least one leaf node,
wherein the at least one non-leaf node comprises data representing a group and the at least one leaf node comprises data representing a discount.

19. The computer-readable medium of claim 18, wherein the group comprises a name, a priority, and an indication of stackability.

20. The computer-readable medium of claim 18, wherein the discount comprises a name, a priority, and an indication of stackability.

21. The computer-readable medium of claim 18, further comprising a discount determination function configured to determine whether a first node in the tree structure comprises a group or a discount.

22. The computer-readable medium of claim 21, wherein the discount determination function is used to traverse the incentive discount data tree by recursively calling the incentive discount function for each sub-node of the first node of the tree.

23. The computer-readable medium of claim 22, further comprising an electronic shopping cart having one or more items available for purchase.

24. The computer-readable medium of claim 22 further comprising a second data tree structure, the second data tree structure comprising groups and discounts.

25. The computer-readable medium of claim 24, wherein the groups and discounts in the second data tree structure are relevant discounts to the items in an electronic shopping cart.

26. The computer-readable medium of claim 25, wherein the relevant discounts are displayed to a user of the electronic shopping cart.

27. The computer-readable medium of claim 26, wherein the relevant discounts include potential discounts and qualified discounts.

28. The computer-readable medium of claim 27, wherein the potential discounts are displayed in conjunction with the shopping cart to notify the user of additional items to purchase to qualify for the potential discounts.

29. The computer-readable medium of claim 28, wherein the potential discounts are based on stackable items in the electronic shopping cart.

30. The computer-readable medium of claim 28, wherein the potential discounts comprise one of a bonus/step rule, a tier scheme rule, and a general discount rule.

31. An electronic system for determining discounts for items, comprising a first server configured to provide a plurality of items to be purchased by a customer;
a second module configured to determine a plurality of applicable discounts for said plurality of items to be purchased; and
a third module configured to apply a discount determination function for selecting a highest discount value from said plurality of applicable discounts for said plurality of items.
